(19) United States
(12) Patent Application Publication
(10) Pub. No.: US 2015/0218360 A1
(43) Pub. Date: Aug. 6, 2015

(54) ACIDIC POLYMER BLENDS FOR POWDER GRANULATION

(71) Applicant: LORD Corporation, Cary, NC (US)

(72) Inventors: Daniel E. Barber, Fuquay-Varina, NC (US); James H. Hogan, Cary, NC (US); Ernest B. Troughton, JR., Raleigh, NC (US)

(73) Assignee: LORD Corporation, Cary, NC (US)

(21) Appl. No.: 14/420,470

(22) PCT Filed: Aug. 15, 2013
(86) PCT No.: PCT/US2013/055039

§ 371 Date: Feb. 9, 2015

Related U.S. Application Data
(60) Provisional application No. 61/683,757, filed on Aug. 16, 2012.

(51) Int. Cl. C08L 33/02; C08L 25/08; C08L 53/00

(52) U.S. Cl. CPC C08L 33/02; C08L 53/00; C08L 25/08

(57) ABSTRACT

A binder formulation is provided including water, a first polymer, and a second polymer. The first polymer is preferred to be a poly(carboxylic acid) and the second polymer is preferred to be a co-polymer containing both carboxylic acid and hydrophobic monomers. The first polymer can be polymers such as poly(acrylic acid), poly(methacrylic acid), poly(maleic acid), or poly(itaconic) acid. The second polymer is preferred to be an alternating copolymer of a monomer of a carboxylic acid and a hydrophobic monomer such as styrene, isobutylene, or n-alkenes. These binder formulations are particularly useful in making granulated powders in powder metallurgy and additive manufacturing.

### CROSS-REFERENCE TO RELATED APPLICATIONS

The present application claims priority under 35 U.S.C. §119(e) from U.S. Provisional Patent Application Ser. No. 61/683,757 filed Aug. 16, 2012, entitled “ACIDIC POLYMER BLENDS FOR POWDER GRANULATION”, the disclosure of which is incorporated herein by reference.

### FIELD OF THE INVENTION

The present invention relates to a binder blend for powder granulation, particularly for powder granulation to be used in a powder molding or additive manufacturing (3D printing) process.

### BACKGROUND OF THE INVENTION

Powder metallurgy (PM) is a set of processes in which powdered metals are compressed and then sintered to form a solid part. Parts from the conventional single press-and-sinter PM process have a maximum possible sintered density of only 88-92% of theoretical. While such parts can be made quickly in high volumes and are useful in some applications, they are not suitable for applications requiring higher strength, ductility, toughness, or corrosion resistance. Consequently, the PM industry has a need for technologies (materials or processes) that allow for the attainment of high sintered density using PM techniques. These techniques generally require additional process steps, higher energy consumption, and longer times, thus significantly increasing the cost of the finished product.

Conventional PM uses irregularly-shaped metal powders, frequently iron or low-alloy iron powders, with an average particle diameter of greater than about 75 microns. The larger particle size is necessary for sufficient powder flow for filling of the dies prior to green compaction, and the irregular shape combined with the relative malleability of low-alloy iron are required to provide the necessary green strength of the pressed compact so that parts can be handled before sintering. The large size and irregular shapes of the particles are a prime reason for the low sintered density of PM parts. Thus, there has been a drive within the industry to use finer metal powders, but such powders suffer from poor flow and very low green strength of the green compact, and they can foul the tooling (dies, punches, etc.) used in the PM process.

Several US patents (U.S. Pat. No. 7,192,464; U.S. Pat. No. 6,585,795; U.S. Pat. No. 6,348,081; U.S. Pat. No. 6,334,882; U.S. Pat. No. 6,126,712; U.S. Pat. No. 5,575,830; U.S. Pat. No. 5,460,641; U.S. Pat. No. 3,945,863) have described attempts to eliminate these difficulties using a granulation process for fine powders, in which the powders are mixed with some type of binder that causes the fine particles to agglomerate into larger aggregates. Of particular note is U.S. Pat. No. 7,163,569, which claims a granulated powder made from fine powder with a mean diameter of less than 8.5 microns and a sintered part with density greater than 97% made from it.

The granulated powder (optionally mixed with lubricant) is then used in a typical PM process, which involves filling of a die cavity with the powder mixture, compaction under pressure, removal of organics at 400-600° C. under a controlled atmosphere, and sintering at a temperature appropriate to achieve the desired final product density. The sintering temperature depends on the metal type and the degree of density desired.

Direct metal laser sintering, or DMLS, is an additive manufacturing technique for direct manufacture of complex metal parts, commonly called “3D printing”. In this process, a thin and uniform layer of metal powder, similar to the type conventionally used in powder metallurgy processes, is deposited on a platen and the metal powder is sintered using a laser in a pattern defined by a computer-assisted design, or CAD, file. The platen is then lowered slightly, a next layer of metal powder is deposited, and this layer is also sintered. By continuing this process for many powder layers, a complex part can be built. When the part is complete, it is removed from the 3D printer, excess powder is removed, and the part can be optionally treated with methods similar to those used for powder metallurgy (e.g., hot isostatic pressing, heat treatment, infiltration, and the like) to improve mechanical properties of the finished part. Additive manufacturing and powder metallurgy process have similar requirements for powder flow and apparent density, but additive manufacturing does not have the additional requirement of high green strength since the part is made by a direct sintering process rather than a high-pressure compaction.

Unfortunately, current binder and lubricant formulations as well as granulation methods fail to provide the flowability, green strength, and density required by the PM industry. In addition, parts made by additive manufacturing require additional process steps to achieve final mechanical properties. It is to these needs that the present invention is directed.

### SUMMARY OF THE INVENTION

In a first aspect of the present invention, a binder formulation is provided comprising water, a first polymer, and a second polymer, wherein the first polymer comprises a poly(carboxylic acid) and the second polymer comprises a co-polymer containing both carboxylic acid and hydrophobic monomers. In one embodiment of the present invention, the first polymer comprises at least one of poly(acrylic acid), poly(methacrylic acid), poly(maleic acid), or poly(itaconic) acid and preferably wherein the first polymer is in its acidic form.

In another embodiment of the present invention, the first polymer has a molecular weight of between 50 kDa and 750 kDa. In a further embodiment of the present invention, the second polymer comprises an alternating copolymer of a monomer of a carboxylic acid and a hydrophobic monomer. In an additional embodiment of the present invention the hydrophobic monomer comprises at least one of styrene, isobutylene, or n-alkenes. In another embodiment of the present invention, the alternating copolymer comprises alternating copolymers with maleic acid. In a still further embodiment of the present invention, the alternating copolymer comprises at least one of poly(styrene-alt-maleic acid), PSMA, poly(isobutylene-alt-maleic acid), poly(diisobutylene-alt-maleic acid), or poly(n-CₘH₂ₘ+1-alt-maleic acid) where m=6, 8, 10, 12, 14, 16, and/or 18.

In another embodiment of the present invention, the first polymer comprises at least 50 weight percent and preferably at least 80 weight percent based on the total polymer content, and the second polymer comprises less than 50 weight percent and preferably less than 20 weight percent based on the total polymer content. In a additional embodiment of the present invention, the formulation contains no polymeric materials other than the first polymer and the second polymer.

In one embodiment of the present invention, the first polymer comprises poly(acrylic acid) with a molecular weight of between about 300 and about 500 kDa, and the second polymer comprises poly(styrene-alt-maleic acid). In another embodiment of the present invention, the mole ratio of styrene to maleic acid comprises from about 1:1 to about 3:1.

In an additional embodiment of the present invention, the first polymer and second polymer are arranged as a block copolymer with a first block of poly(carboxylic acid), and a second block, of an alternating hydrophobic/acidic copolymer. In one embodiment of the present invention, the first polymer is present in the block copolymer in an amount of at least 50 weight percent, based on the total weight of the block copolymer. In another embodiment of the present invention, the first polymer is present in the block copolymer in an amount of least 80 weight percent based on the total weight of the block copolymer.

In a further embodiment of the present invention, the binder formulation is in a mixture comprising the binder formulation and a metal powder wherein the binder formulation is present in an amount of less than about 2 percent based on the weight of the mixture. In another embodiment of the present invention, the binder formulation is present in an amount less than about 1 percent based on the weight of the mixture. In a additional embodiment of the present invention, the metal powder comprises an average particle diameter of about 10 microns or less. An in a still further embodiment of the present invention, the mixture is employed in an additive manufacturing process.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

### DETAILED DESCRIPTION OF THE INVENTION

A first aspect of the present invention provides binder formulations that can be used in an aqueous spray-drying process to convert fine, non-flowing powder into coarser, free-flowing granules that, when compacted under pressures from 100-600 MPa, will produce a green body with sufficient handling strength for subsequent processing.

Embodiments of the invention described herein focus on simultaneous improvement of at least two of several properties, including powder flow and apparent density, green strength, process yield, and performance after exposure to humidity. Flow and green strength are particularly important for powder metallurgy, whereas flow and apparent density but not green strength are particularly important for additive manufacturing.

In a first embodiment of the present invention, a binder formulation is provided comprising at least two water-soluble polymers. The first polymer comprises a poly(carboxylic acid) and the second polymer comprises a co-polymer containing both carboxylic acid and hydrophobic monomers.

While not wishing to be bound by the theory, it is believed that the first polymer contributes primarily to high green strength of the compacted part, whereas the second polymer provides improved yield from the spray dry process and better powder flow, particularly after exposure to humidity.

In another embodiment of the present invention, the first polymer comprises at least 50% by weight and preferably at least 80% by weight of the total polymer content, and the second polymer should be less than 50% by weight and preferably less than 20% by weight of the total polymer content. In a further embodiment of the present invention, the binder formulation consists of water and a first polymer and a second polymer in the aforementioned ratios.

In a further embodiment of the present invention, the first polymer comprises at least one of poly(acrylic acid) (“FAA”), poly(methacrylic acid) (“PMAA”), poly(maleic acid) (“PMA”), poly(itaconic acid) (“PIA”), and the like. Further, the first polymer may comprise a poly(di- or tri-caryboxylic acid). This polymer needs to be water-soluble, with a minimum solubility of at least 1% polymer by weight in aqueous solution, and in its acidic form for best green strength of the compacted part. Higher molecular weight material, preferably between 50 kDa and 750 kDa (kDa=kilodalton), and most preferably between 300-500 kDa, is preferred, as long as the viscosity of the material in a binder formulation allows for good flow of the slurry (made up of metal powder and aqueous polymer solution) for spray drying.

In another embodiment of the present invention, the second polymer comprises an alternating copolymer of one of the aforementioned-type acids and another hydrophobic monomer such as styrene, isobutylene, n-alkenes, and the like; particularly preferred are the alternating copolymers with maleic acid, such as poly(styrene-alt-maleic acid), PSMA, poly(isobutylene-alt-maleic acid), poly(diisobutylene-alt-maleic acid), and poly(n-CₘH₂ₘ+1-alt-maleic acid) where m=6, 8, 10, 12, 14, 16, and/or 18. To improve water solubility, the second polymer can be used in its anionic (neutralized) form, as long as the pH of aqueous solutions of the combined first and second polymers is acidic (less than about pH 5). Because higher amounts of this material tend to lower the green strength of the compacted part, it is preferable to use the lowest relative amount of this material (compared to the first polymer) that will provide the necessary spray dry process yield, flow, and humidity resistance. In an embodiment of the present invention, wherein the binder formulation is to be used in a 3D printing process, powder flow and apparent density are the most important attributes for the granulated powder so higher relative amount of the secondary binder may be acceptable.

In a still further embodiment of the present invention, a binder formulation is provided comprising a block copolymer wherein the block copolymer contains segments corresponding to the first polymer and the second polymer noted above. In a preferred embodiment of the invention, the block copolymer comprises one block, at least 50% and preferably at least 80%, of poly(carboxylic acid), and a second block, less than 50% and preferably less than 20%, of an alternating hydrophobic/acidic copolymer as described above. In this manner, the functionalities of the first and second polymers described above are embodied in one copolymer molecule, which operates in a way that is functionally similar to having two separate polymers mixed.

In one embodiment of the present invention, the total amount of binder formulation applied to the metal powder during granulation comprises from 0.5 to about 2% by weight of the metal powder. In another embodiment of the present invention, the total amount of polymeric binder used in the process comprises less than about 1.5% by weight, and preferably less than 1.0% by weight of the metal powder.

The fine metal powder used in granulated powders can be of any desired metal or alloy, or mixture of metals or alloys, with an average particle diameter less than about 15 microns, with less than 10 microns particularly preferred. The powder can be prepared from any of the typical methods, including water atomization, gas atomization, chemical precipitation, electrochemical deposition, or gas-phase synthesis including the carbonyl process for iron, nickel and the like. The powder shape and morphology is generally not restricted, although particles with a spherical shape and with a distribution of sizes (with the largest particles no more than 20 microns diameter) are preferable because they can pack most efficiently before sintering. Powders with the highest possible tap density as compared to their theoretical density are most preferred. It is likely that the exact types and amounts of binders required for good green strength will vary with the type of fine metal powder used.

These fine powders can be granulated by any of several known methods, including fluid bed granulation, spray drying, sieving, high-speed mixing (or high-shear granulation), rotating drum granulation, or drying and crushing. Fluid bed or high-shear granulation may be accomplished by spraying a solution of the binder formulation onto the particles as they are being agitated. If the binder solution is applied by one of these methods, the viscosity of the binder solution should preferably be less than about 200 centipoise (cP) for best application. The other methods generally will use a slurry comprised of the binder formulation, solvent, and the fine metal powder. Spray drying comprises a particularly attractive granulation method for the application of the binder formulations of this invention. If the binder is applied by spray drying of a metal powder-containing slurry, the viscosity of the slurry including binder, solvent and metal powder should preferably be less than about 1000 cP, preferably in the range form 200-500 cP. Lower binder content is better for removal in the thermal processing steps, provided that the green strength of the pressed part is sufficiently high. The average diameter of the granulated powder should be at least 50 microns to ensure good flowability, with an average size between 75 and 150 microns most preferred. If the granulated powder is intended for a 3D printing process, an average size down to about 20 microns is preferred.

The granulated powder can optionally be mixed with any of a number of lubricants commonly used in the powder metallurgy industry, with zinc stearate and a stearamide known commercially as Acrawax® available from Lonza, Inc. as the preferred lubricants. Other lubricants include PS1000b from Apex Advanced Technologies, LLC, and lauric acid.

In another embodiment of the present invention, the binder formulation is applied to the metal powder through the use of a solvent, which is subsequently evaporated. A preferred solvent is water, though other materials capable of evaporation such as glycols, or even organic solvents may be employed. In one preferred formulation for a binder composition of an embodiment of the present invention, the two binders are mixed with water wherein the binder formulation comprises about 0.1 to about 5 percent binder by weight in an aqueous solution, with a concentration of 1-3 weight percent binder particularly preferred. One practiced in the art will understand that the exact concentration will depend on the application method being used and the viscosity limitations of that method.

In an additional embodiment of the present invention, the granulated powder made with the binder formulation of the present invention may be utilized along with granulated metal powder(s) made with binder formulations different than those described herein.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

### Examples

Granulated powder mixtures were prepared by spray drying slurries containing metal powder at about 70% by weight with 30% by weight of an aqueous solution containing the various binders in the amounts required to reach the total dry binder content and binder ratios shown in the tables. Samples were sifted through 80 mesh and 400 mesh screens, and only the −80/+400 mesh material was used for subsequent flow and green strength tests. Powder samples were pressed at 375 MPa pressure into cylindrical green compacts with diameter 0.75 inches and mass of about 5.0 g. Density was determined by calculation from the mass and dimensions of the green compact, and the green strength was determined from the radial crush strength according to the Brazilian method.

Data showing some of the advantages of embodiments of the present invention are compiled in Tables 1 and 2. Table 1 summarizes powder yield from the spray dry process along with selected powder and green body properties. Entries 1 and 2 are repeat batches of a commonly-used PVA (poly(vinyl alcohol)) polymer. The production yield for this material is known to be in the range of 85-90%, so the observed 48-50% yield in the lab-scale spray dryer is considered good. Flow and green properties for this material are considered as the benchmark. Lower flow and higher green strength values are the desired goals to demonstrate improvement.

PAA binder alone (Table 1, entries 3 and 4) gave very good green strength but poor process yield and flow. Initial binder blend tests comparing PEAA (poly(ethylene-co-acrylic acid)), a water-insoluble copolymer provided as an aqueous emulsion, and the water-soluble neutralized PSMA (1:1) showed that the PSMA (1:1) gave significantly improved yield (entries 5-6). Process yield improved but green strength decreased as the percentage of PSMA was increased (entries 7-9); an 85:15 ratio was judged to be a good compromise for further experiments testing different secondary binder types. A sulfonated poly(styrene), containing styrene groups but no carboxylic acid groups, gave modest yield and green strength but good powder flow (entry 10), and PSMA with higher styrene content (entry 13) also gave only modest yield. PVA as a secondary binder (entry 11) gave poor yield but reasonable green strength, and PEO (poly(ethylene oxide), entry 12) gave excellent yield but rather poor green strength.

Table 2 shows the effects of high humidity on the powder flow for selected samples. Only the styrene-containing polymers, PSMA and sulfonated PS (Table 2, entries 3-6 and 11-14), maintained acceptable flow after exposure to high-humidity conditions that eliminated flow in the PAA-only and PVA-only reference materials (entries 1-2 and 9-10, respectively). Taken together, the data in Tables 1 and 2 show that the blends of PAA with PSMA (1:1) give the best overall combination of improved process yield and high green strength while maintaining good flow under normal and high humidity conditions.

TABLE 1
Powder and Green Body Properties

| | | | | | | | Spray | | | | |
|---|---|---|---|---|---|---|---|---|---|---|---|
| | | | | Total | Slurry | Slurry | Dry | | | Green | Green |
| | Binder A | Binder B | A/B Ratio | Binder | metal | metal | Process | -38 pm | Flow | Density | Strength |
| Entry | Type | Type | (wt/wt) | (Wt %) | Wt % | Vol % | Yield | yield | (sec/50 g) | (g/cm³) | (MPa) |
| 1 | PVA | — | — | 0.86 | 80 | 34 | 50.3 | 41% | 28.5 | 5.79 | 3.3 |
| 2 | PVA | — | — | 0.86 | 68 | 22 | 47.9 | 39% | 29.3 | 6.09 | 2.9 |
| 3 | PAA | — | — | 0.86 | 70 | 23 | 16.0 | 51% | 41.4 | 5.84 | 4.0 |
| 4 | PAA | — | — | 0.86 | 70 | 23 | 11.8 | 37% | 37.0 | 5.74 | 5.0 |
| 5 | PAA | PEAA | 90:10 | 0.95 | 70 | 23 | 12.9 | 54% | 31.7 | 5.80 | 3.9 |
| 6 | PAA | PSMA | 90:10 | 0.95 | 70 | 23 | 28.4 | 64% | 35.2 | 5.75 | 4.3 |
| | | (1:1) | | | | | | | | | |
| 7 | PAA | PSMA | 90:10 | 0.86 | 70 | 23 | 37.9 | 32% | 28.2 | 5.80 | 3.6 |
| | | (1:1) | | | | | | | | | |
| 8 | PAA | PSMA | 80:20 | 0.86 | 70 | 23 | 59.2 | 52% | 29.8 | 5.78 | 3.1 |
| | | (1:1) | | | | | | | | | |
| 9 | PAA | PSMA | 85:15 | 0.86 | 70 | 23 | 49.6 | 34% | 28.5 | 5.85 | 3.5 |
| | | (1:1) | | | | | | | | | |
| 10 | PAA | Sulfonated | 85:15 | 0.86 | 70 | 23 | 25.4 | 28% | 25.8 | 5.80 | 3.7 |
| | | PS | | | | | | | | | |
| 11 | PAA | PVA | 85:15 | 0.86 | 70 | 23 | 18.7 | 28% | 29.3 | 5.88 | 3.5 |
| 12 | PAA | PEO | 85:15 | 0.86 | 70 | 23 | 63.2 | 53% | 29.3 | 5.86 | 3.0 |
| 13 | PAA | PSMA | 85:15 | 0.86 | 70 | 23 | 39.0 | 29% | | | |
| | | (3:1) | | | | | | | | | |

Notes:
Total binder weight percent is based on dried granulated metal powder
Green density and green strength were measured on a green body compacted at 375 MPa pressure
PSMA (1:1) is the alternating copolymer of styrene and maleic acid, whereas PSMA (3:1) is a copolymer with a styrene:maleic acid ra 3:1.

TABLE 2
Humidity Effects on Powder Flow

| | | | | | Flow | |
|---|---|---|---|---|---|---|
| | | | | | Before | Flow After |
| | Binder A | Binder B | A/B Ratio | Humidity | Humidity | Humidity |
| Entry | Type | Type | (wt/wt) | Test | (sec/50 g) | (sec/50 g) |
| 1 | PAA | — | — | 38 C./65% | 41.4 | no flow |
| | | | | RH/16 hr | | |
| 2 | PAA | — | — | 38 C./65% | 37.0 | no flow |
| | | | | RH/16 hr | | |
| 3 | PAA | PSMA (1:1) | 90:10 | 38 C./65% | 28.2 | 28.66 |
| | | | | RH/16 hr | | |
| 4 | PAA | PSMA (1:1) | 80:20 | 38 C./65% | 29.8 | 30.87 |
| | | | | RH/16 hr | | |
| 5 | PAA | PSMA (1:1) | 85:15 | 38 C./65% | 28.5 | 29.62 |
| | | | | RH/16 hr | | |
| 6 | PAA | Sulfonated | 85:15 | 38 C./65% | 25.8 | 26.49 |
| | | PS | | RH/16 hr | | |
| 7 | PAA | PVA | 85:15 | 38 C./65% | 29.3 | plugged |
| | | | | RH/16 hr | | flow |
| 8 | PAA | PEO | 85:15 | 38 C./65% | 29.3 | no flow |
| | | | | RH/16 hr | | |
| 9 | PVA | — | — | 38 C./75% | 26.1 | no flow |
| | | | | RH/16 hr | | |
| 10 | PVA | — | — | 38 C./75% | 29.3 | no flow |
| | | | | RH/16 hr | | |
| 11 | PAA | PSMA (1:1) | 90:10 | 38 C./75% | 27.8 | 35.4 |
| | | | | RH/16 hr | | |
| 12 | PAA | PSMA (1:1) | 80:20 | 38 C./75% | 30.8 | 33.4 |
| | | | | RH/16 hr | | |
| 13 | PAA | PSMA (1:1) | 85:15 | 38 C./75% | 29.2 | 32.7 |
| | | | | RH/16 hr | | |
| 14 | PAA | Sulfonated | 85:15 | 38 C./75% | 25.8 | 34.9 |
| | | PS | | RH/16 hr | | |

What is claimed is:

1. A binder formulation comprising water, a first polymer, and a second polymer, wherein the first polymer comprises a poly(carboxylic acid) and the second polymer comprises a co-polymer containing both carboxylic acid and hydrophobic monomers.

2. The binder formulation of claim 1, wherein the first polymer comprises at least one of poly(acrylic acid), poly(methacrylic acid), poly(maleic acid), or poly(itaconic) acid.

3. The binder formulation of claim 1, wherein the first polymer is in its acidic form.

4. The binder formulation of claim 1, wherein the first polymer has a molecular weight of between 50 kDa and 750 kDa.

5. The binder formulation of claim 1, wherein the second polymer comprises an alternating copolymer of a monomer of a carboxylic acid and a hydrophobic monomer.

6. The binder of claim 5, wherein the hydrophobic monomer comprises at least one of styrene, isobutylene, or n-alkenes.

7. The binder formulation of claim 5, wherein the alternating copolymer comprises alternating copolymers with maleic acid.

8. The binder formulation of claim 7, wherein the alternating copolymer comprises at least one of poly(styrene-alt-maleic acid), PSMA, poly(isobutylene-alt-maleic acid), poly(diisobutylene-alt-maleic acid), or poly(n-CₘH₂ₘ+1-alt-maleic acid) where m=6, 8, 10, 12, 14, 16, and/or 18.

9. The binder formulation of claim 1, wherein the first polymer comprises at least 50 weight percent and preferably at least 80 weight percent based on the total polymer content, and the second polymer comprises less than 50 weight percent and preferably less than 20 weight percent based on the total polymer content.

10. The binder formulation of claim 1, wherein the formulation contains no polymeric materials other than the first polymer and the second polymer.

11. The binder formulation of claim 1, wherein the first polymer comprises poly(acrylic acid) with a molecular weight of between about 300 and about 500 kDa, and the second polymer comprises poly(styrene-alt-maleic acid).

12. The binder formulation of claim 8, wherein the mole ratio of styrene to maleic acid comprises from about 1:1 to about 3:1.

13. The binder formulation of claim 1, wherein the first polymer and second polymer are arranged as a block copolymer with a first block of poly(carboxylic acid), and a second block, of an alternating hydrophobic/acidic copolymer.

14. The binder formulation of claim 13, wherein the first polymer is present in the block copolymer in an amount of at least 50 weight percent, based on the total weight of the block copolymer.

15. The binder formulation of claim 13, wherein the first polymer is present in the block copolymer in an amount of least 80 weight percent based on the total weight of the block copolymer.

16. The binder formulation of claim 1 in a mixture comprising the binder formulation and a metal powder wherein the binder formulation is present in an amount of less than about 2 percent based on the weight of the mixture.

17. The binder formulation of claim 16, wherein the binder formulation is present in an amount less than about 1 percent based on the weight of the mixture.

18. The binder formulation of claim 16, wherein the metal powder comprises an average particle diameter of about 10 microns or less.

19. The binder formulation of claim 16, wherein the mixture is employed in an additive manufacturing process.
